(19) United States
(12) Patent Application Publication
(10) Pub. No.: US 2010/0281212 A1
(43) Pub. Date: Nov. 4, 2010

(54) CONTENT-BASED WRITE REDUCTION

(76) Inventor: Arul Selvan, Thottampatti (IN)

Correspondence Address: SCHWEGMAN, LUNDBERG & WOESSNER/NOVELL, PO BOX 2938, MINNEAPOLIS, MN, 55402, US

(21) Appl. No.: 12/432,024

(22) Filed: Apr. 29, 2009

(51) Int. Cl. G06F 12/06

(52) U.S. Cl. 711/114; 711/154; 711/E12.078

(57) ABSTRACT

Apparatus, systems, and methods may operate to detect a write request to write new data to a storage medium, to generate a coded version of the new data, to compare the coded version of the new data to a coded version of old data stored in the storage medium, and to refrain from writing the new data to the storage medium when the coded version of the new data is equal to the coded version of the old data. Additional apparatus, systems, and methods are disclosed.

### BACKGROUND

Mass storage systems are generally designed to improve hard disk performance by using block allocation algorithms, caching to memory, and a variety of other mechanisms. However, when a write request is received, regardless of the content, the blocks are usually written to the disk at some later time.

### SUMMARY

In various embodiments, apparatus, systems, and methods that support content-based write reduction are provided. For example, in some embodiments, a reduction in the amount of write activity can be realized by detecting a write request to write new data to a storage medium, generating a coded version of the new data, comparing the coded version of the new data to a coded version of old data stored in the storage medium, and refraining from writing the new data to the storage medium when the coded version of the new data is equal to the coded version of the old data. Additional embodiments are described, and along with the foregoing examples, will be set forth in detail below.

### BRIEF DESCRIPTION OF THE DRAWINGS

FIG. 1 is a flow diagram illustrating methods of content-based write reduction according to various embodiments of the invention.

FIG. 2 is another flow diagram illustrating methods of content-based write reduction according to various embodiments of the invention.

FIG. 3 is a block diagram of apparatus and systems according to various embodiments of the invention.

FIG. 4 is a block diagram of an article of manufacture, including a specific machine, according to various embodiments of the invention.

### DETAILED DESCRIPTION

Some of the challenges described above with respect to improving file system write performance may be addressed by implementing intelligent write operations that are based on the content to be written. For example, if it can be determined that content previously stored in a designated area of a storage medium is the same as content that has been scheduled to be written to the same area, there is no need to write the content to the medium a second time, and the write operation can be avoided.

To carry out this type of comparison in an efficient manner, the data to be written may be represented by a compact, coded version, such as a hash of the data. In some embodiments, the coded version of the data can be stored as file meta data, which may include a variety of other information, such as the file creation date, modification date, owner, trustee, rights, attributes, etc.

Some file systems include superblocks (a record of file system characteristics), inode data structures (meta data storage area), and data blocks. In some embodiments, file meta data can be stored in a data structure, such as an inode data structure, or in data blocks. The actual file data may be provided by a variety of sources, including data streams, and can be stored in data blocks.

Thus, in some embodiments, a hash of the data stored in file data blocks can be stored as meta data, and used to later identify one or more blocks of data that are about to be overwritten. Upon detecting a file block overwrite operation, a hash of the new data (to be written) can be calculated and compared with a hash of the old data (that has already been written).

If the data that has already been written is the same as the data that has yet to be written (as determined by matching coded versions of the two sets of data), the data storage system can operate to refrain from writing the new data. In this way, file system performance can be improved. Thus, in some embodiments, before writing each data block to the disk, a hash of the data is calculated and stored along with the existing meta data for that block. The hash of the data can be calculated before or after the block of data is cached in memory.

Therefore, in some embodiments, when a write request is received for a particular block of data, a hash of the new data and the hash of the old (previously-written) data are compared. If there is a match, the write operation for the new data is discarded. If there is no match, the new block of data is written to the disk and the hash of the new data is updated/stored in the meta data space. The data to be written can be cached, regardless of whether the write operation is discarded, in some embodiments.

The mechanism described herein can be used as an extension to an existing file system, or as a script/tool on a server. It may be useful to prevent unnecessary write activity to slower storage media, such as single hard disks, and disk arrays. For example, consider the following implementation that includes operating to store/write blocks of data that are 4096 bytes in size, along with a hash of 16 bytes that is calculated and stored in the file meta data for each block.

When a word processing application is used to edit a document associated with a data file, a request to write the entire document file to the hard disk may be issued, even when only a small change has been made to the document. Thus, when the original document data file is opened for modification, the application may attempt to send the entire file to the hard disk, even if the change to the document serves merely to increase the data file size from 8192 bytes (two blocks) to 8200 bytes.

However, if the hash for every 4096 bytes of data is stored in the file meta data, instead of blindly writing the entire file to disk, the hash of the file blocks (for each 4096 bytes) can be calculated prior to writing, and compared with the original (previously stored) hash. In this example, the first two blocks of the data file do not need to be written—thus, 8192 bytes are skipped (discarded) in the write process since the same data is already available on the disk. The remaining 8 bytes are written to the disk. Thus, unnecessary write operations are avoided, and the file server performance is enhanced. The amount of improvement may increase in proportion to the file size.

Therefore, many embodiments of the invention may be realized, and each can be implemented in a variety of architectural platforms, along with various operating and server systems, devices, and applications. Any particular architectural layout or implementation presented herein is therefore provided for purposes of illustration and comprehension only, and is not intended to limit the various embodiments.

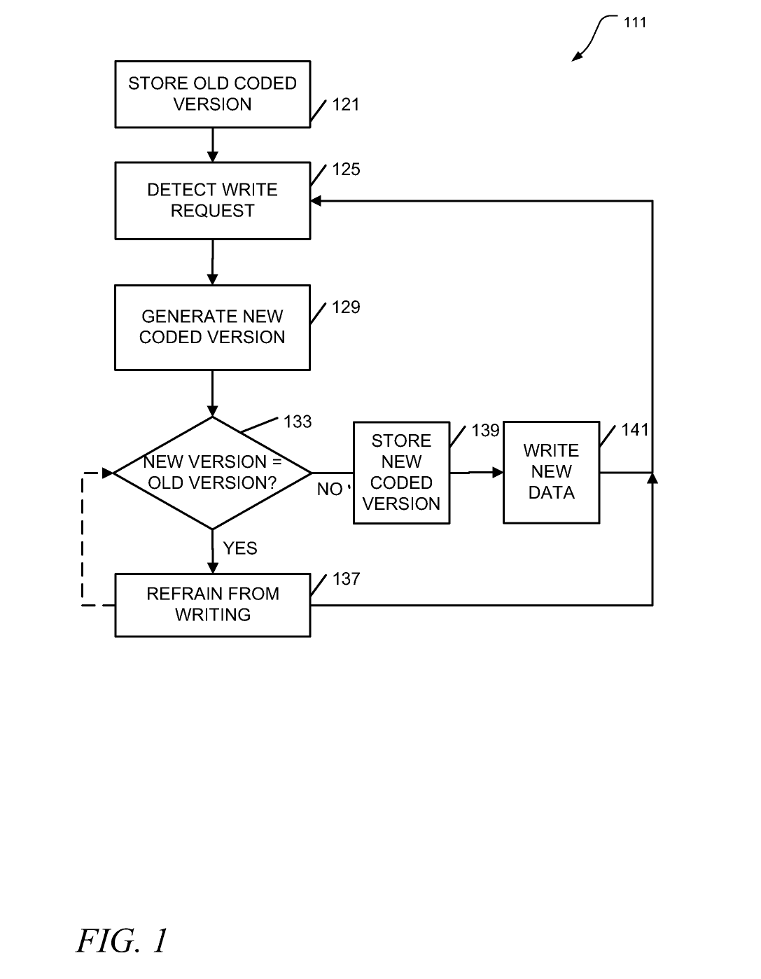

FIG. 1 is a flow diagram illustrating methods 111 of content-based write reduction according to various embodiments of the invention. The methods 111 are implemented in a machine-accessible and readable medium and are operational over processes within and among networks. The networks may be wired, wireless, or a combination of wired and wireless. The methods 111 may be implemented as instructions, which when accessed by a specific machine, perform the processing depicted in FIG. 1. Given this context, content-based write reduction is now discussed with reference to FIG. 1.

In some embodiments, as viewed from the perspective of an apparatus or program controlling write operations to a storage medium, a write request is received, a coded version of the new data to be written is generated and compared against the coded version of existing data in the same area, and the new data is not written to the storage medium if the two coded versions match. A processor-implemented method 111 to execute on one or more processors that perform this method of managing write operations to a storage medium may thus begin with storing a coded version of the old (existing) data at block 121. The coded version may comprise a portion of data file meta data or block meta data to be stored in a meta data storage area.

The method 111 may continue on to block 125 with detecting a write request to write new data to an area of the storage medium where old data has previously been written. The storage medium may comprise one or more disks, and the area of the storage medium to be written may comprise one or more blocks of memory.

The write request may be initiated by user activity, such as when a user clicks a mouse button to activate the “SAVE” command for an application program. Thus, the write request may be associated with detecting the selection of a save command used in a word processing application program, a spreadsheet application program, a presentation application program, and/or a calendar processing application program, among others.

The method 111 may continue on to block 129 with generating a coded version of the new data. Coding may comprise creating a cyclic redundancy check (CRC) code or a hash of the (new) data to be written, for example. Some examples of hashing algorithm types that are known to those of ordinary skill in the art include cryptographic hashing functions (e.g., SHA-1, MD2, MD5), collision-resistant hash functions (CRHF), and universal one-way hash functions (UOWHF).

The method 111 may continue on to block 133 with comparing the coded version of the new data to a coded version of old data, where the new data is to be written to the same location/area as that used to store the old data.

If the comparison at block 133 results in a match between the coded versions, indicating the data to be written is the same as the data previously stored, then the method 111 may continue on to block 137 with refraining from writing the new data to the media storage area when the coded version of the new data is equal to the coded version of the old data.

In some embodiments, writing the data over several blocks (or other measurable units of data) may be preempted until coded data comparisons no longer result in a match. Thus, the method 111 may comprise repeating the refraining (at block 137) for a plurality of blocks in a single file until a hash of the data to be written to one of the plurality of blocks is not equal to a hash of the data already written to that one block (as determined at block 133).

If the coded versions of the old and new data do not match, as determined at block 133, then the activity of writing the data to the storage medium may proceed. Thus, if the comparison at block 133 does not result in a match, then the method 111 may continue on to block 139 with storing the coded version of the new data in a meta data storage area.

The method 111 may then continue on to block 141 with writing the new data to the designated storage medium area when the coded version of the new data differs from the coded version of the old data. Other embodiments may be realized.

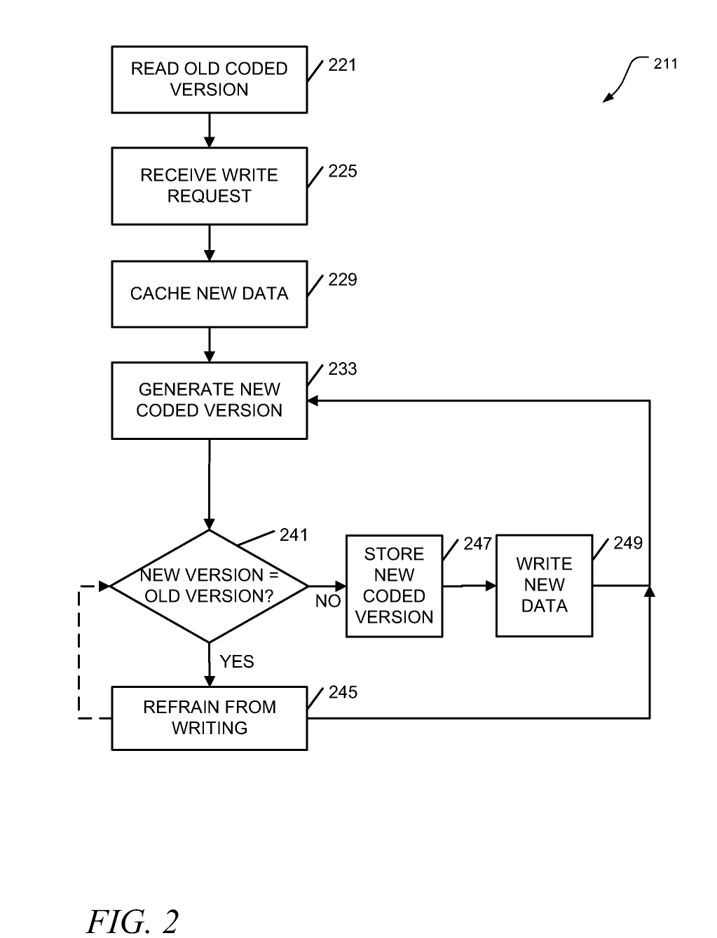

For example, FIG. 2 is another flow diagram illustrating methods 211 of content-based write reduction according to various embodiments of the invention. In this case, the methods 211 focus on the activities of a server coupled to a multi-disk storage medium. The methods 211 are implemented in a machine-accessible and readable medium, and are operational over processes within and among networks. The networks may be wired, wireless, or a combination of wired and wireless. The methods 211 may be implemented as instructions, which when accessed by a specific machine, perform the processing depicted in FIG. 2.

When the server is booted, some or all of the file meta data, including the coded versions of previously-stored (old) data, may be read into memory. Thus, in some embodiments, a processor-implemented method 211 that can be executed on one or more processors that perform this method may begin at block 221 with reading a coded version of the old data into memory responsive to booting the server.

The method 211 may continue on to block 225 with receiving, at the server, a write request to write new data to an area of a multi-disk storage medium coupled to the server. The area of the multi-disk storage medium to be written may comprise one or more blocks.

Clients coupled to the server may initiate data write requests. Thus, the activity at block 225 may comprise receiving the write request from one of a plurality of clients coupled to the server by a network.

The data to be written may be cached before or after the coded version of the new data is generated. Thus, the method 211 may continue on to block 229 to include storing the new data in a data cache prior to generating a coded version of the new data.

The method 211 may continue on to block 233 with generating a coded version of the new data. As noted previously, the data coding may be accomplished according to a hash algorithm, or a CRC algorithm, among others. Thus, the coded version of the new data may comprise a hash coded version of the new data or a CRC coded version of the new data.

The method 211 may continue on to block 241 with comparing the coded version of the new data to a coded version of the old data (stored in the same area of the multi-disk storage medium). If the comparison results in a match of the coded versions, then the method 211 may continue on to block 245 with refraining from writing the new data to the multi-disk storage medium when the coded version of the new data is equal to the coded version of the old data. In some embodiments, this activity of comparison (at block 241) and refraining from writing (at block 245) may be repeated over a number of blocks of data.

The coded version of the data can be stored in a variety of locations, including a meta data storage area. Thus, if the comparison at block 241 does not result in a match, then the method 211 may continue on to block 247 with storing the coded version of the new data in a meta data storage area.

The method 211 may then continue on to block 249 with writing the new data to the area of the storage medium where the old data was previously written/stored. When the coded version of the old data does not exist (e.g., it is the first time the method 211 is executed with respect to a particular area of the storage medium), the new data can be used to overwrite the old data, and a coded version of the new data can be generated. Thus, the activity at block 249 may include writing the new data to the designated area of the multi-disk storage medium when the coded version of the old data does not exist.

The methods described herein do not have to be executed in the order described, or in any particular order. Moreover, various activities described with respect to the methods identified herein can be executed in repetitive, serial, or parallel fashion. The individual activities of the methods shown in FIGS. 1 and 2 can also be combined with each other and/or substituted, one for another, in various ways. Information, including parameters, commands, operands, and other data, can be sent and received in the form of one or more carrier waves. Thus, many other embodiments may be realized.

The methods of content-based write reduction shown in FIGS. 1 and 2 can be implemented in a computer-readable storage medium, where the methods are adapted to be executed by one or more processors. Further details of such embodiments will now be described.

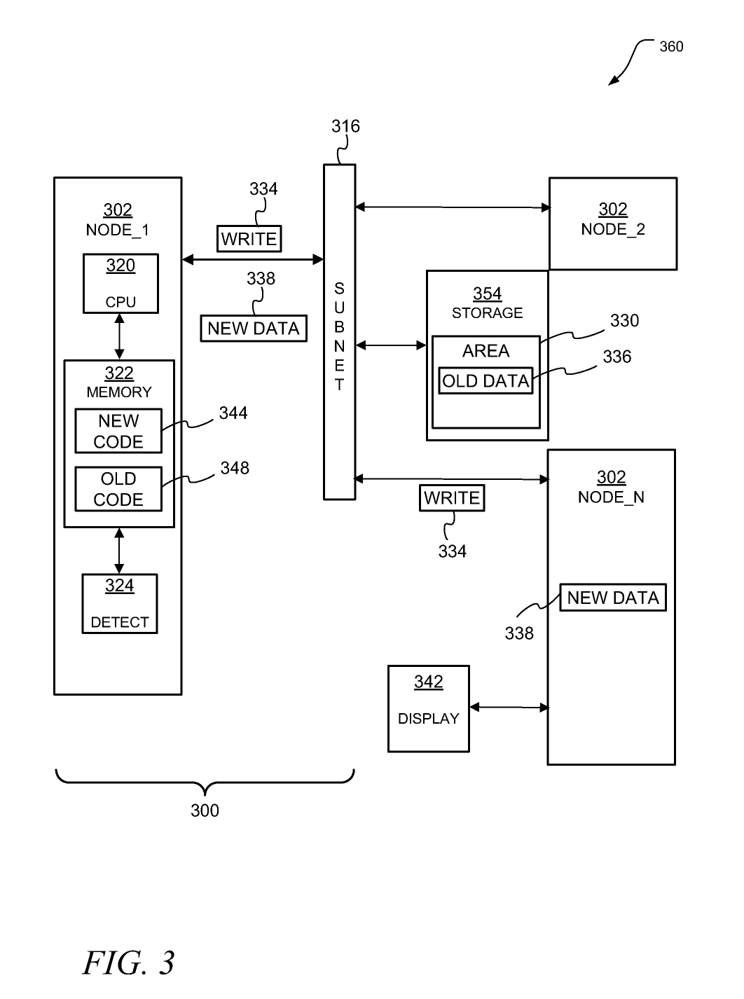

FIG. 3 is a block diagram of apparatus 300 and systems 360 according to various embodiments of the invention. Here it can be seen that an apparatus 300 used to implement content-based write reduction may comprise one or more processing nodes 302, one or more processors 320, memory 322, and a write detection module 324. The processing nodes 302 may comprise physical machines or virtual machines, or a mixture of both. The nodes 302 may also comprise networked entities, such servers and/or clients.

In some embodiments, then, an apparatus 300 may comprise a node 302 including a detection module 324 to detect a write request 334 to write new data 338 to an area 330 of a storage medium 354. The apparatus 300 may also comprise one or more processors 320 to generate a coded version 344 of the new data, to compare the coded version 344 of the new data to a coded version 348 of old data 336 stored in the area 330, and to prevent writing the new data 338 to the area 330 when the coded version 344 of the new data is equal to the coded version 348 of the old data.

The apparatus 300 might comprise a server, including a physical server or a virtual server, as well as a desktop computer, a laptop computer, a PDA, or a cellular telephone. The apparatus 300 may also comprise a client, or perhaps an independent processing node. In some embodiments, multiple non-intelligent clients (e.g., NODE_2 and NODE_N) can interact with a smart server (e.g., NODE_1) that operates both to initiate a write request, and to evaluate the request prior to writing data to the storage medium 354.

The apparatus 300 may house the storage medium 354, or not (as shown). Thus, in some embodiments, the apparatus 300 comprises the storage medium 354. The storage medium 354 may comprise an array of disks, including a RAID (redundant array of inexpensive disks) system.

Similarly, the apparatus 300 may house the meta data storage (as shown), or not. Thus, in some embodiments, the apparatus 300 comprises a memory 322 to store the coded version 348 of the old data as meta data associated with a file containing the old data 336. Still further embodiments may be realized.

For example, it can be seen that a system 360 that operates to reduce write activity based on the content to be written may comprises multiple instances of the apparatus 300. The system 360 might also comprise a cluster of nodes 302, including physical and virtual nodes. Thus, in some embodiments, a system 360 may comprise at least two separate processing entities: a first entity to initiate the write request, and a second entity to receive it.

Therefore, a system 360 may comprise a first node (e.g., NODE_N) to issue a write request 334 associated with new data 338 comprising at least a portion of a data file. The system 360 may also comprise a second node (e.g., NODE_1 or NODE_2) including a detection module 324 and a processor 320, as described above.

The system 360 may further include one or more displays 342. Thus, in some embodiments, the system 360 comprises a display 342 coupled to the first node (e.g., NODE_N) to display a visible representation of the portion of the data file to be written (e.g., new data 338).

The apparatus 300 and system 360 may be implemented in a machine-accessible and readable medium that is operational over one or more networks 316. The networks 316 may be wired, wireless, or a combination of wired and wireless. The apparatus 300 and system 360 can be used to implement, among other things, the processing associated with the methods 111 and 211 of FIGS. 1 and 2, respectively. Modules may comprise hardware, software, and firmware, or any combination of these. Additional embodiments may be realized.

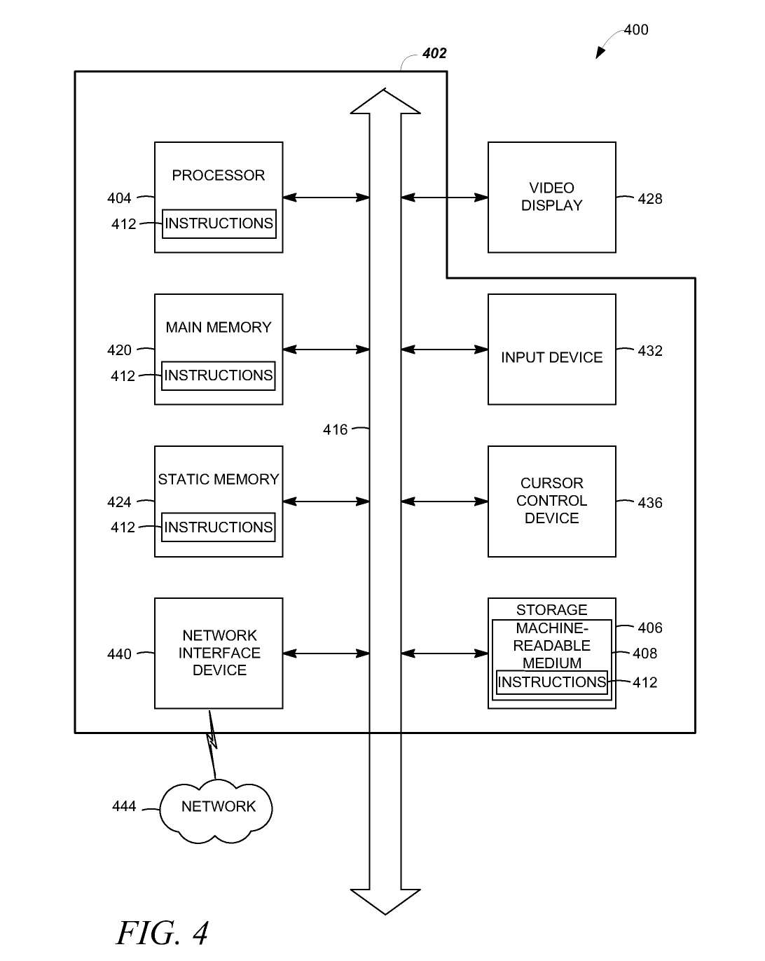

For example, FIG. 4 is a block diagram of an article 400 of manufacture, including a specific machine 402, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 400 of manufacture, such as a computer, a memory system, a magnetic or optical disk, some other storage device, and/or any type of electronic device or system may include one or more processors 404 coupled to a machine-readable medium 408 such as a memory (e.g., removable storage media, as well as any memory including an electrical, optical, or electromagnetic conductor) having instructions 412 stored thereon (e.g., computer program instructions), which when executed by the one or more processors 404 result in the machine 402 performing any of the actions described with respect to the methods above.

The machine 402 may take the form of a specific computer system having a processor 404 coupled to a number of components directly, and/or using a bus 416. Thus, the machine 402 may be similar to or identical to the apparatus 300 or system 360 shown in FIG. 3.

Turning now to FIG. 4, it can be seen that the components of the machine 402 may include main memory 420, static or non-volatile memory 424, and mass storage 406. Other components coupled to the processor 404 may include an input device 432, such as a keyboard, or a cursor control device 436, such as a mouse. An output device 428, such as a video display, may be located apart from the machine 402 (as shown), or made as an integral part of the machine 402.

A network interface device 440 to couple the processor 404 and other components to a network 444 may also be coupled to the bus 416. The instructions 412 may be transmitted or received over the network 444 via the network interface device 440 utilizing any one of a number of well-known transfer protocols (e.g., HyperText Transfer Protocol). Any of these elements coupled to the bus 416 may be absent, present singly, or present in plural numbers, depending on the specific embodiment to be realized.

The processor 404, the memories 420, 424, and the storage device 406 may each include instructions 412 which, when executed, cause the machine 402 to perform any one or more of the methods described herein. In some embodiments, the machine 402 operates as a standalone device or may be connected (e.g., networked) to other machines. In a networked environment, the machine 402 may operate in the capacity of a server or a client machine in server-client network environment, or as a peer machine in a peer-to-peer (or distributed) network environment.

The machine 402 may comprise a personal computer (PC), a tablet PC, a set-top box (STB), a PDA, a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 402 is illustrated, the term “machine” shall also be taken to include any collection of machines that individually or jointly execute a set (or multiple sets) of instructions to perform any one or more of the methodologies discussed herein.

While the machine-readable medium 408 is shown as a single medium, the term “machine-readable medium” should be taken to include a single medium or multiple media (e.g., a centralized or distributed database, and/or associated caches and servers, and or a variety of storage media, such as the registers of the processor 404, memories 420, 424, and the storage device 406 that store the one or more sets of instructions 412. The term “machine-readable medium” shall also be taken to include any medium that is capable of storing, encoding or carrying a set of instructions for execution by the machine and that cause the machine 402 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Implementing the apparatus, systems, and methods described herein may operate to increase the performance of mass storage systems by permitting such systems to bypass duplicative write operations. More efficient allocation of data processing resources may result.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a node including a detection module to detect a write request to write new data to an area of a storage medium; and
a processor to generate a coded version of the new data, to compare the coded version of the new data to a coded version of old data stored in the area, and to prevent writing the new data to the area when the coded version of the new data is equal to the coded version of the old data.

2. The apparatus of claim 1, further comprising:
the storage medium.

3. The apparatus of claim 1, further comprising:
a memory to store the coded version of the old data as meta data associated with a file containing the old data.

4. A system, comprising:
a first node to issue a write request associated with new data comprising at least a portion of a data file; and
a second node including a detection module to detect the write request to write the new data, and a processor to generate a coded version of the new data, to compare the coded version of the new data to a coded version of old data stored in an area of a storage medium, and to prevent writing the new data to the area when the coded version of the new data is equal to the coded version of the old data.

5. The system of claim 4, wherein the storage medium comprises:
an array of disks.

6. The system of claim 4, further comprising:
a display coupled to the first node to display a visible representation of the portion.

7. A processor-implemented method to execute on one or more processors that perform the method, comprising:
detecting a write request to write new data to an area of a storage medium;
generating a coded version of the new data;
comparing the coded version of the new data to a coded version of old data stored in the area; and
refraining from writing the new data to the area when the coded version of the new data is equal to the coded version of the old data.

8. The method of claim 7, further comprising:
storing the coded version of the old data as meta data prior to the detecting.

9. The method of claim 8, wherein the meta data comprises a portion of file meta data.

10. The method of claim 7, further comprising:
writing the new data to the area when the coded version of the new data differs from the coded version of the old data.

11. The method of claim 7, wherein the storage medium comprises:
a disk.

12. The method of claim 7, wherein the area comprises at least one block of memory.

13. The method of claim 7, wherein the coded version of the new data comprises a hash of the new data.

14. The method of claim 7, wherein the write request is associated with detecting selection of a save command used in one of a word processing application program, a spreadsheet application program, a presentation application program, or a calendar processing application program.

15. The method of claim 7, further comprising:
repeating the refraining for a plurality of blocks in a single file until a hash of the data to be written to one of the plurality of blocks is not equal to a hash of the data already written to the one of the plurality of blocks.

16. A processor-implemented method to execute on one or more processors that perform the method, comprising:
receiving, at a server, a write request to write new data to an area of a multi-disk storage medium coupled to the server;
generating a coded version of the new data;
comparing the coded version of the new data to a coded version of old data stored in the area of the multi-disk storage medium; and
refraining from writing the new data to the area of the multi-disk storage medium when the coded version of the new data is equal to the coded version of the old data.

17. The method of claim 16, wherein the receiving further comprises:
receiving the write request from one of a plurality of clients coupled to the server by a network.

18. The method of claim 16, wherein the coded version of the new data comprises a hash coded version of the new data or a cyclic redundancy check coded version of the new data.

19. The method of claim 16, further comprising:
storing the new data in a data cache prior to the generating.

20. The method of claim 16, further comprising:
storing the coded version of the new data in a meta data storage area.

21. The method of claim 16, further comprising:
reading the coded version of the old data into memory responsive to booting the server.

22. The method of claim 16, wherein the area of the multi-disk storage medium comprises a plurality of blocks.

23. The method of claim 16, further comprising:
writing the new data to the area of the multi-disk storage medium when the coded version of the old data does not exist.
